(19) United States
(12) Patent Application Publication
(10) Pub. No.: US 2009/0319386 A1
(43) Pub. Date: Dec. 24, 2009

(54) AUCTION MECHANISM WHEN AUCTIONEER IS A BIDDER

(75) Inventors: Kamal Jain, Bellevue, WA (US); David John Abraham, Pittsburgh, PA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/141,943

(22) Filed: Jun. 19, 2008

(51) Int. Cl. G06Q 30/00

(52) U.S. Cl. 705/26

(57) ABSTRACT

A system that facilitates executing an auction when an auctioneer is also a bidder is described herein. The system includes a receiver component that receives an indication that an auction is to be executed and an identifier component that determines that the auctioneer is a bidder in the auction. The system also includes an auction component that executes an auction for one or more items based at least in part upon a determination that the auctioneer is a bidder and a rank of the bid of the auctioneer amongst all receive bids.

### BACKGROUND

A large portion of revenue from web search engines is derived from advertisers purchasing advertising space adjacent to search result listings. More specifically, web search engines use keyword auctions to sell advertising space alongside search results listings. For instance, a graphical user interface corresponding to a search engine can include a query field that is configured to receive a query from a user. The query will include a keyword (which may be an individual word or a collection of words), and advertisers can bid on the keyword to purchase advertising space thereon.

Pursuant to an example, a user may proffer a keyword “camera” to the search engine. Various camera manufacturers may desire to display an advertisement adjacent to search results for the query, as it may be inferred that the user has an interest in a topic related to a camera, and therefore may have an interest in purchasing a camera.

Companies that manage search engines today typically offer a wide array of products and services, including operating systems, video-game consoles, photo-sharing websites, word processing applications, spreadsheet applications, financial management applications, amongst other products and services. Thus, like other merchants, a search engine company may wish to bid for an advertising position in a keyword auction. It can be discerned, however, that the search engine company runs the auction, and therefore a conflict of interest exists. For instance, the search engine company can submit a bid in an attempt to obtain higher bid prices from other participants in an auction. Even if the search engine company bids truthfully, the possibility that the search engine company may bid untruthfully may deter prospective bidders from bidding in a keyword auction.

### SUMMARY

The following is a brief summary of subject matter that is described in greater detail herein. This summary is not intended to be limiting as to the scope of the claims.

Described herein are various technologies pertaining to auctions. More particularly, technologies relating to auctions where an auctioneer (and/or owner of an item that is to be auctioned) is a bidder is described herein. In an example, an auction may be a single-item auction, and the auctioneer may bid on the item. If the auctioneer is one of the top two bidders, the auctioneer can be allocated to the item. For instance, the item may be an advertising position that is to be displayed adjacent to search results listings.

In another example, the auction may be an auction for multiple items, such as a multi-item single-unit demand auction. For instance, the auction may be for k items. The auctioneer can submit a bid to win the auction for one of the k items, and other bidders may also submit bids to win the auction for one of the k items. A determination can be made as to the rank of the bid from the auctioneer amongst the bids from the other bidders.

If the auctioneer is not amongst the k+1 highest bidders, the k highest bidders may be allocated to the k items. Furthermore, the k highest bidders may be charged a price that corresponds to a bid submitted by the k+1 highest bidder.

If the auctioneer is amongst the k highest bidders, the auctioneer (and other bidders in the k highest bidders) may be allocated to the k items. The auctioneer and other bidders in the k highest bidders may be charged a price that corresponds to a bid submitted by the k+1 highest bidder. In another example, the auctioneer and other bidders in the k highest bidders may be charged a price that corresponds to a bid submitted by the k+2 highest bidder.

If the auctioneer is the k+1 highest bid, the bid from the auctioneer can be removed (e.g., not considered). The k highest bidders may be allocated to the k items. Moreover, the auctioneer may be allocated to one of the k items. Thus, more than k bidders may be allocated to the k items. Accordingly, one of the other bidders (e.g., one of the k highest bidders) can be removed from the auction, thereby resulting in k winners of the auction. Removal of the one of the other bidders may be undertaken randomly, may be undertaken by way of a deterministic rule, etc. The k winners of the auction may be charged a price that corresponds to a bid submitted by the k+2 highest bidder.

Furthermore, auctions described herein may be undertaken in a search engine, where a keyword is received and several merchants (bidders) bid on advertising positions on a search results page that corresponds to the keyboard. It is to be understood, however, that the mechanisms described herein may be employed in other auction settings where the auctioneer and/or owner of one or more items being auction desirably bids on such item(s).

Other aspects will be appreciated upon reading and understanding the attached figures and description.

### BRIEF DESCRIPTION OF THE DRAWINGS

FIG. 1 is a functional block diagram of an example system that facilitates executing an auction when an auctioneer is a bidder in the auction.

FIG. 2 is a functional block diagram of an example auction component that can allocate bidders, including an auctioneer, to one or more items.

FIG. 3 is an example depiction of a single-item auction when an auctioneer is a bidder.

FIG. 4 is an example depiction of a multi-item auction when an auctioneer is a bidder.

FIG. 5 is an example depiction of a multi-item auction when an auctioneer is a bidder.

FIG. 6 is an example depiction of a multi-item auction when an auctioneer is a bidder.

FIG. 7 is a functional block diagram of an example system that facilitates locating bidders based at least in part upon a received search query.

FIG. 8 is a functional block diagram of an example system that facilitates generating a search results page that includes advertisements.

FIG. 9 is an example graphical user interface.

FIG. 10 is a flow diagram that illustrates an example methodology for determining whether to allocate an auctioneer to an item.

FIG. 11 is a flow diagram that illustrates an example methodology for determining whether to allocate an auctioneer to an item in a multi-item single-unit demand auction.

FIG. 12 is a flow diagram that illustrates an example methodology for allocating an auctioneer to an item.

FIGS. 13 and 14 depict a flow diagram that illustrates an example methodology for determining whether to allocate an auctioneer to an item.

FIG. 15 is an example computing system.

### DETAILED DESCRIPTION

Various technologies pertaining to auctions in general, and more particularly pertaining to keyword auctions where the auctioneer is also a bidder will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

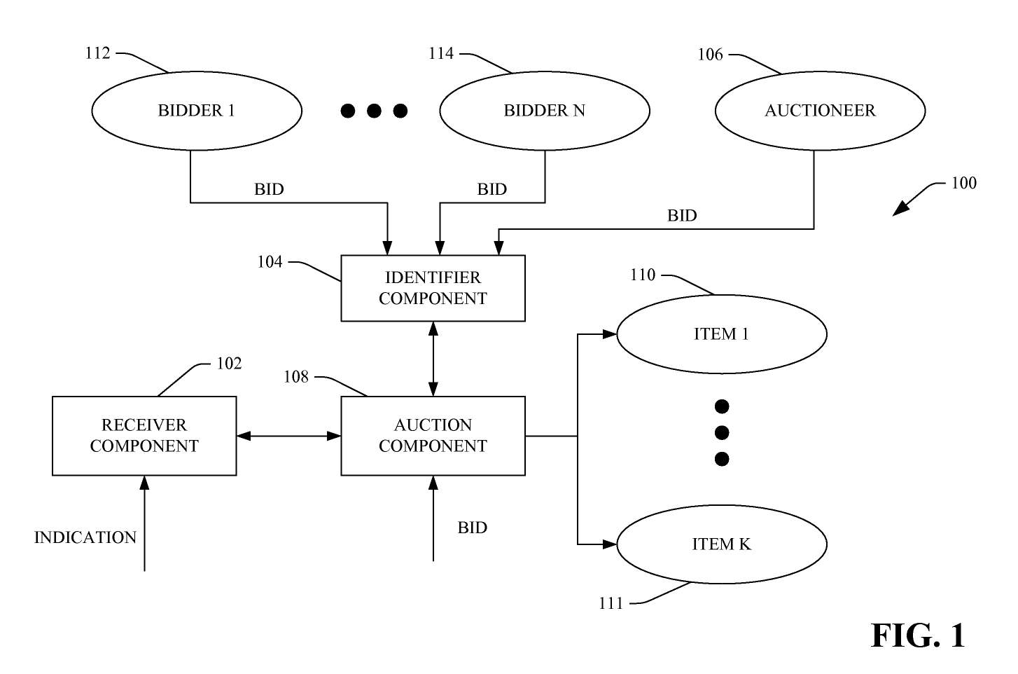

Referring now to the drawings, FIG. 1 illustrates a system 100 that facilitates executing an auction when an auctioneer is also a bidder. As used herein, the term “auctioneer” is intended to encompass an owner of an item that is available by way of auction. For instance, a search engine may comprise the system 100, and the search engine may be the auctioneer and the bidder. The system 100 includes a receiver component 102 that receives an indication that an auction is to be executed. For instance, such indication may be in the form of a keyword that is received from a user in connection with the user desirably performing a search. The keyword may be one or more words, an acronym, a number, a combination of words and numbers, a sequence of alphanumerical characters, etc. In another example, the indication may be an auctioneer announcing that an auction is going to take place.

The system 100 may additionally include an identifier component 104 that can determine that an auctioneer 106 is a bidder in the auction. In addition, if desired, the identifier component 104 can determine identities of other bidders in the auction. In an example, the auctioneer 106 may be a search engine, and the receiver component 102 can receive a keyword that pertains to instant messaging. The auctioneer 106 may offer an instant messaging service, and therefore may wish to advertise such service. An appearance of a conflict of interest may exist, however, as other bidders may believe that the auctioneer 106 is bidding to inflate an amount of a winning bid, thereby increasing revenue for the auctioneer 106.

An auction component 108 can execute an auction for one or more items 110-111 based at least in part upon a determination that the auctioneer 106 is a bidder and a determined rank of the bid of the auctioneer amongst all receive bids. For instance, the items 110-111 may be advertising positions that can be presented adjacent to search results listings pertaining to a keyword. More specifically, the auction component 108 can receive bids from a plurality of bidders 112-114 and can additionally receive a bid from the auctioneer 106. The auction component 108 can execute the auction based at least in part upon a type of auction mechanism that is employed, a number items (e.g., substantially similar items) available in the auction, and an amount the auctioneer 106 bids in comparison to bids of the plurality of bidders 110-114.

In an example, the auction component 108 can use a Vickrey auction mechanism. A Vickrey auction mechanism is a sealed-bid mechanism, where bidders are unaware of bids of other bidders in the auction. To incentivize bidders to bid truthfully, the highest bidder wins the auction but pays the price that corresponds to the second-highest bidder. In a conventional multi-item auction (e.g., positional auction) that employs the Vickrey auction mechanism, when k items are available for auction, the top k bidders win the auction but pay a price that corresponds to the k+1 bidder. In another example, the auction component 108 may use the Vickrey-Clarke-Groves auction mechanism or a suitable variant thereof. In yet another example, the auction component 108 may use a generalized second price auction mechanism, which has been tailored for Internet auctions. For purposes of explanation, the following examples are described in connection with a generalized sealed-bid auction mechanism—it can be understood, however, that any of the above auction mechanisms or other suitable auction mechanisms can be employed by the auction component 108. Examples of the auction component 108 executing are described in greater detail herein.

Furthermore, the system 100 may be implemented in connection with a search engine that executes auctions for advertising positions that can be displayed adjacent to search results on a graphical user interface. Thus, the item 110 may be an advertising position or multiple advertising positions. In another example, the auction can be a MUSID auction for tokens in a layered auction. Layerable mechanisms for utilization in positional auctions are described in detail in Microsoft Docket No. 323614.01, filed on ______, with inventors of Jain, Abraham, and Asadpour, and entitled LAYERABLE AUCTION MECHANISMS, the entirety of which is incorporated herein by reference.

Pursuant to an example, the receiver component 102 may receive a keyword or a plurality of keywords, which is an indication that an auction for one or more advertising positions is underway. The bidders 112-114 can bid on advertising positions pertaining to the keyword, wherein if the bidder wins the auction an advertisement of the bidder will be displayed adjacent to search results pertaining to the keyword. For instance, the bid may relate to an amount that the bidder is willing to pay to a search engine if a user clicks on an advertisement of the bidder. In addition, the auctioneer 106 can submit a bid with respect to the keyword. If the identifier component 104 determines that the auctioneer 106 has submitted a bid, the auction component 108 can allocate advertising positions to bidders based at least in part upon a determination that the auctioneer 106 is a bidder, a number of items available by way of the auction, a determined rank of the bid of the auctioneer amongst all receive bids.

While the examples described herein discuss bids in the traditional sense (e.g., what is bid by a bidder is what will be paid by the bidder), it is to be understood that bids can be altered based on various factors. For instance, if the auctioneer 106 is a search engine, the auction component 108 may wish to take into consideration a click-through rate corresponding to the bidder when allocating items to bidders. That is, if the bidder has an extremely low click-through rate, the auctioneer may desire to assign a weight to the bid that is independent of the bid. The auction component 108 can allocate bidders to positions based upon a true bid price (e.g., an amount actually bid by a bidder) or based upon a weighted bid price (e.g., weighted to maximize revenue).

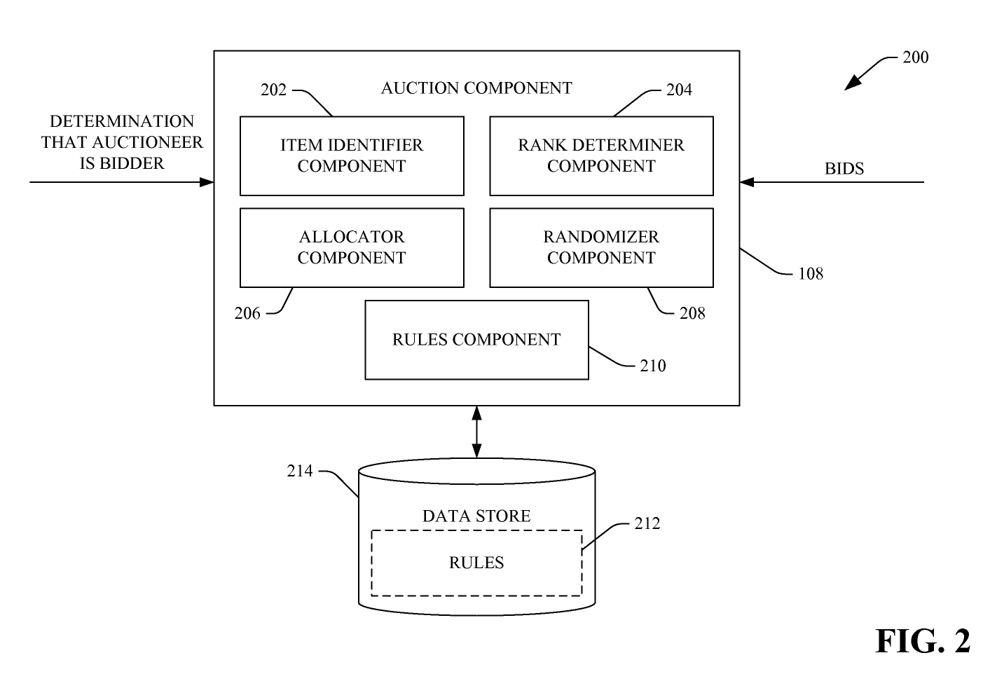

Now turning to FIG. 2, an example detailed depiction 200 of the auction component 108 is illustrated. While the auction component 108 is illustrated as including numerous components, it is to be understood that delineation of components is for purposes of explanation only.

The example auction component 108 receives a determination that the auctioneer 106 (FIG. 1) is a bidder as well as bids from the auctioneer and other bidders. The auction component 108 includes an item identifier component 202 that can determine a number of items that are available by way of the auction. For instance, the item identifier component 202 can determine whether the auction is a single-item auction or a multi-item auction. Furthermore, the item identifier component 202 can determine a precise number of items that are available by way of the auction.

The auction component 108 may additionally include a rank determiner component 204 that can determine where a bid from the auctioneer 106 ranks in comparison to bids received from other bidders. For instance, the rank determiner component can determine, amongst p bidders, where the bid of the auctioneer 106 ranks.

An allocator component 206 can allocate bidders to positions based at least in part upon whether the auctioneer 106 is a bidder, the rank of the bid of the auctioneer 106 as determined by the rank determiner component 204, and a number of items available for purchase by way of the auction as determined by the item identifier component 202.

In some instances, as will be described below, a greater number of bidders will be allocated to items than there are available items (e.g., the allocation of bidders to items will be overpacked). Thus, the auction component 108 may include a randomizer component 208 that can be used to randomly select one or more bidders that have been allocated to items and remove such bidder(s) as winners of the auction.

Furthermore, the auction component 108 may include a rules component 210 that can execute one or more rules 212 that are retained in a data repository 214. For instance, as noted above, a greater number of bidders may be allocated to items than there are available items. Rather than randomly selecting a bidder for removal, a deterministic rule can be employed to remove a bidder as a winner of the auction. In an example, a rule executed by the rules component 210 may remove a bidder that is earliest or latest in the alphabet when compared to other bidders that have been allocated to items. In another example, a rule executed by the rules component 210 may remove a bidder that has most recently altered a bid when compared to other bidders that have been allocated to items. Other deterministic rules are also contemplated and are intended to fall under the scope of the hereto-appended claims.

In addition, the rules 212 retained in the data repository 214 may also include other rules pertaining to the auction, such as rules related to minimum bids, maximum bids, restricted bidders, etc. For instance, the rules component 210 can enforce a rule that requires submitted bids to be above a threshold minimum bid. In another example, the rules component 210 can disallow certain bidders from bidding in particular auctions (e.g., bids presented by restricted bidders can be thrown out by the rules component 212).

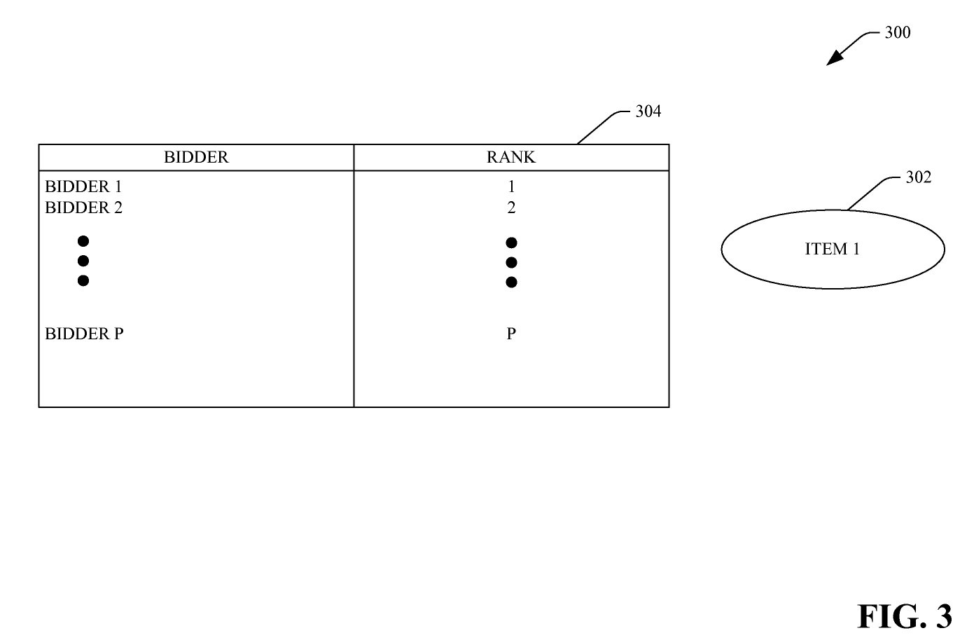

Referring now to FIG. 3, an example depiction 300 of an auction undertaken by the auction component 108 is illustrated. In this example, a single item 302 is available for purchase by way of auction. A bid table 304 indicates where bidders rank amongst all bidders. The item identifier component 202 can determine that the auction is a single-item auction, and the identifier component 104 (FIG. 1) can determine that an auctioneer 106 is a bidder in the single-item auction. The ranker determiner component 204 can determine where the bid of the auctioneer 106 ranks with respect to bids received by other bidders.

If the bid of the auctioneer 106 is among the two highest bids, the allocator component 206 can allocate the auctioneer 106 to the item 302, and the auctioneer 106 can be charged a price that corresponds to the second highest bid. Thus, if the second-highest bidder is the auctioneer 106, then the allocator component 206 can allocate the auctioneer 106 to the item 302, and the auctioneer 106 can be charged a price that is based at least in part upon the bid submitted by the auctioneer 106. For instance, the allocator component 206 can charge the auctioneer 106 for the item 302. If the auctioneer 106 is the highest bidder, then the allocator component 206 can allocate the auctioneer 106 to the item 302, and the auctioneer 106 can be charged a price that is based at least in part upon the bid submitted by the second highest bidder. If, however, the bid submitted by the auctioneer 106 is not one of the two highest bids, the allocator component 206 can allocate the highest bidder to the item 302, and the highest bidder can be charged a price that corresponds to a bid submitted by the second-highest bidder.

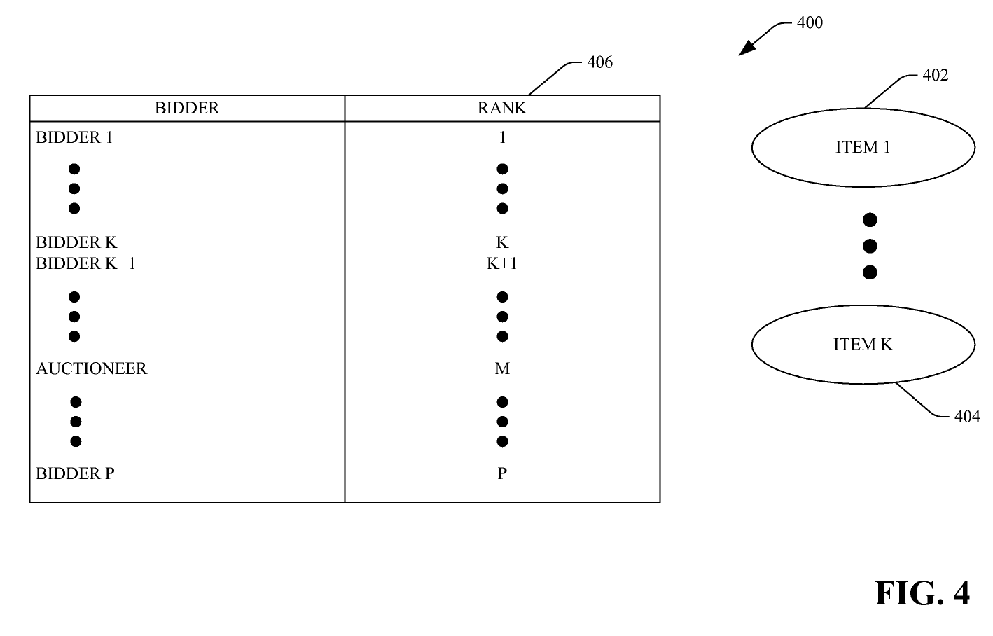

With reference now to FIG. 4, another example depiction 400 of an auction undertaken by the auction component 108 is illustrated. In this example, k items 402-404 are available for purchase by way of the auction. For instance, the auction may be a MUSID auction, a positional auction, or other suitable auction. A bid table 406 illustrates a bid position of the auctioneer 106 amongst other bidders.

The identifier component 104 can determine that the auctioneer 106 is a bidder in the auction, and the item identifier component 202 can determine that multiple items are available by way of the auction. In this example, p bidders can bid for the items 402-404, and the rank determiner component 204 can determine that the auctioneer 106 is the mth bidder in the auction, which is not among the k+1 highest bidders (e.g., the k+1 highest bidders value the items 402-404 more highly than the auctioneer 106 values the items 402-404). The allocator component 206 can allocate the k highest bidders to the k items 402-404, and can further charge a price to the k highest bidders that corresponds to a bid submitted by the k+1 highest bidder.

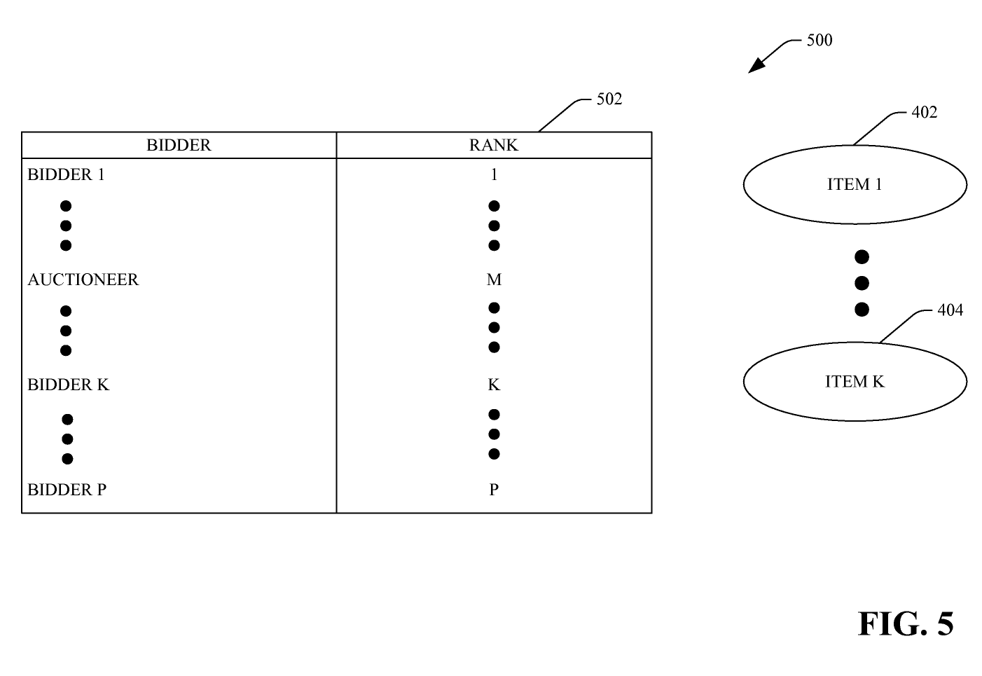

Now referring to FIG. 5, yet another example depiction 500 of an auction undertaken by the auction component 108 is illustrated. In this example, the k items 402-404 are available for purchase by way of the auction. A bid table 502 illustrates a bid position of the auctioneer 106 amongst other bidders.

The identifier component 104 can determine that the auctioneer 106 is a bidder in the auction, and the item identifier component 202 can determine that multiple items are available by way of the auction. In this example, p bidders can bid for the items 402-404, and the rank determiner component 204 can determine that the auctioneer 106 is the mth bidder in the auction, which is among the k highest bidders. The allocator component 206 can allocate the k highest bidders to the k items 402-404—thus the auctioneer 106 can be allocated to one of the items 402-404. Furthermore, the allocator component 206 can charge a price to the k highest bidders that corresponds to a bid submitted by the k+1 highest bidder. In another example, the allocator component 206 can charge a price to the k highest bidders that corresponds to a bid submitted by the k+2 highest bidder—therefore, the bid of the auctioneer 106 is entirely discounted (e.g., the bidders that win the auction will pay as though the auctioneer 106 never submitted a bid).

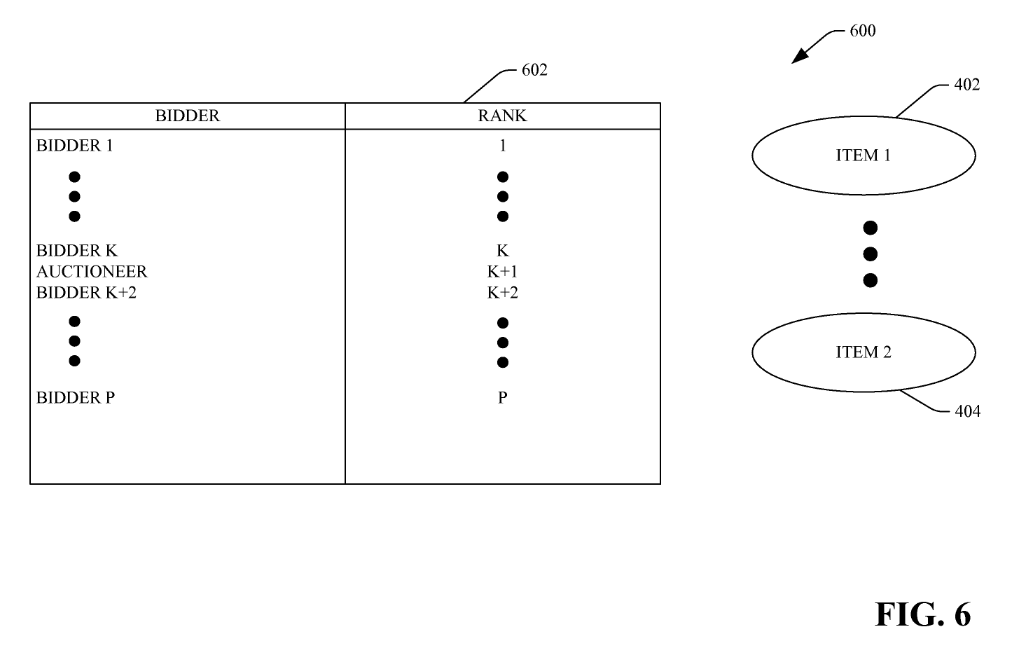

Now referring to FIG. 6, still yet another example depiction 600 of an auction undertaken by the auction component 108 is illustrated. In this example, the k items 402-404 are available for purchase by way of the auction. A bid table 602 illustrates a bid position of the auctioneer 106 amongst other bidders.

The identifier component 104 can determine that the auctioneer 106 is a bidder in the auction, and the item identifier component 202 can determine that multiple items are available by way of the auction. In this example, p bidders can bid for the items 402-404, and the rank determiner component 204 can determine that the auctioneer 106 is the k+1 bidder in the auction. In this example, the allocator component 206 can withdrawal the bid of the auctioneer 106 from the auction. Once such bid has been withdrawn, the allocator component 206 can allocate the k highest bidders to the items 402-404, and can charge a price to such bidders that corresponds to the bid of the k+2 bidder (e.g., the bidder that had a lower adjacent rank to the bid of the auctioneer 106). The allocator component 206 may also allocate the auctioneer 106 to one of the items 402-404, thereby allocating more bidders to items than there are items (e.g., the items are overpacked).

Pursuant to an example, the randomizer component 208 can randomly select one of the bidders that won an item in the auction and remove the selected bidder. In another example, the rules component 210 can execute a deterministic rule (described above) to select one of the bidders that won an item in the auction and remove the selected bidder from the auction. As noted above, the allocator component 206 can charge a price that corresponds to a bid of the k+2 bidder.

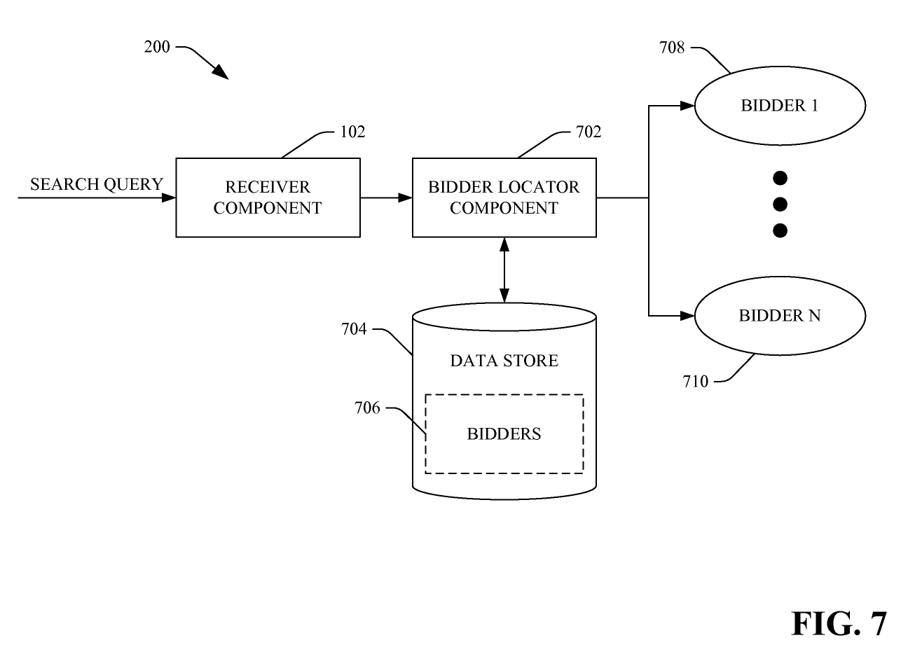

Referring now to FIG. 7, an example system 700 that facilitates determining bidders that desire to bid on an item or items available by way of auction is illustrated. As noted above, an auction executed as described herein may be an auction undertaken by way of the Internet generally, and more specifically a keyword auction. In particular, advertisers often wish to purchase advertising positions adjacent to search results that are located based upon one or more keywords (e.g., to determine bidders for a received keyword) is illustrated.

The system 700 includes the receiver component 102 that receives at least one keyword (e.g., in the form of a search query) from a user. A bidder locator component 702 can receive and process the keyword and locate merchants (bidders) that desire to bid on advertising positions on a search page that presents search results pertaining to the keyword. For instance, the bidder locator component 702 can access a data store 704 that includes numerous prospective bidders 706, and can locate bidders that wish to bid on the received keywords. More particularly, prospective bidders can indicate which keyword(s) or combination of keywords towards which they wish to direct advertisements. Furthermore, the auctioneer 106 can be amongst the bidders 706 in the data store 704. Resulting bidders 708-710 can then bid in the auction undertaken by the auction component 108 (FIG. 1).

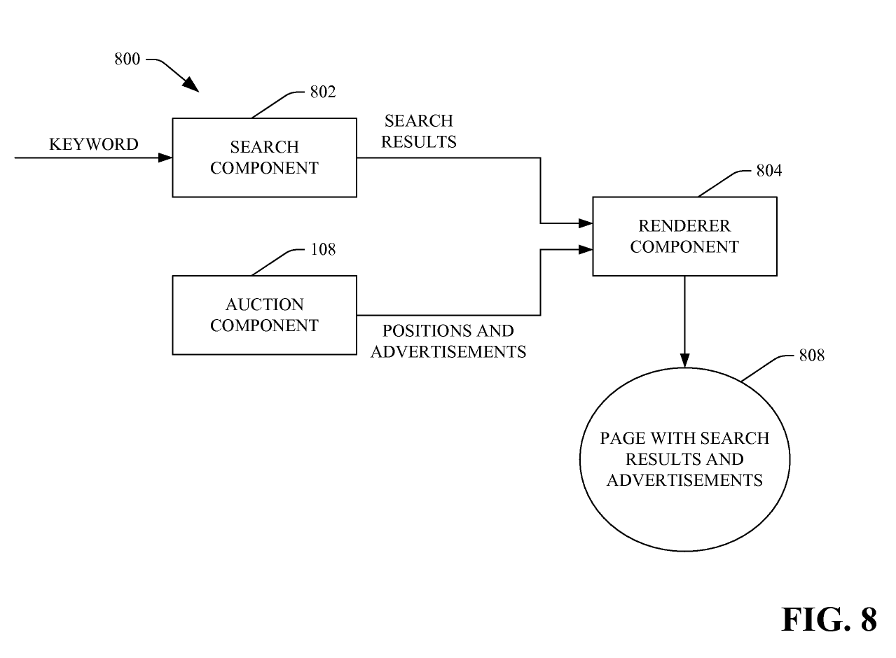

With reference now to FIG. 8, an example system 800 that facilitates provision of a search page to a user that includes a list of search results and advertisements in particular positions is depicted. The system 800 includes a search component 802 that receives one or more keywords, and the search component 802 can search for documents based at least in part upon the received one or more keywords. As used herein, a document may be a web page, an image, a video, a word processing document, a spreadsheet application, an audio item, an XML document, and/or other suitable document.

The system 800 can further include the auction component 108, which can execute an auction as described above. More particularly, the auction component 108 can allocate bidders to positions on a search results page based at least in part upon a number of items that are available by way of the auction, a determination regarding whether the auctioneer 106 (FIG. 1) is a bidder, and a rank of the bid of the auctioneer 106 amongst other bids. A renderer component 804 can render a search page 806 that includes search results pertaining to the received one or more keywords as well as advertisements that are depicted at positions bid upon by several bidders. More specifically, the advertisements can

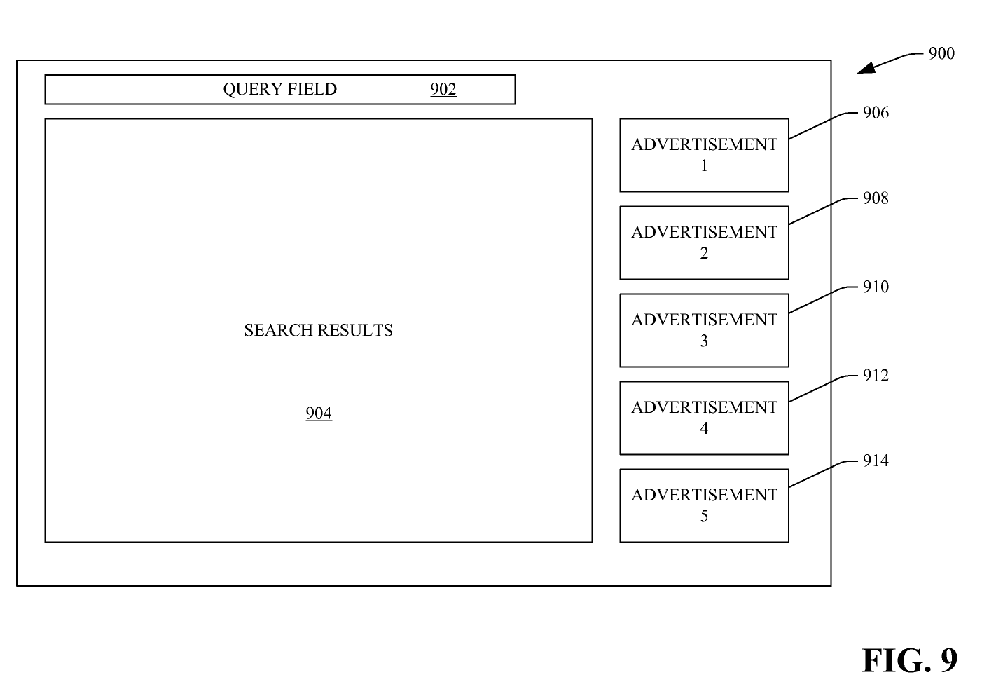

Turning now to FIG. 9, an example graphical user interface 900 that presents advertisements in advertising positions is illustrated. The advertisements can correspond to advertisers determined by the auction component 108 (FIG. 1). For instance, one of the advertisements may correspond to the auctioneer 106. The graphical user interface 900 includes a query field 902 that is configured to receive search queries (one or more keywords) from a user. The graphical user interface 900 also includes a search results field 404 that is configured to present a listing of search results to a user. The search results comprise be hypertext links to web pages, for instance. In another example, the search results may include images, video, or the like. The graphical user interface 900 additionally includes a plurality of advertisements 906-914 that are placed in particular positions in accordance with an allocation of bidders to positions by the auction component 108.

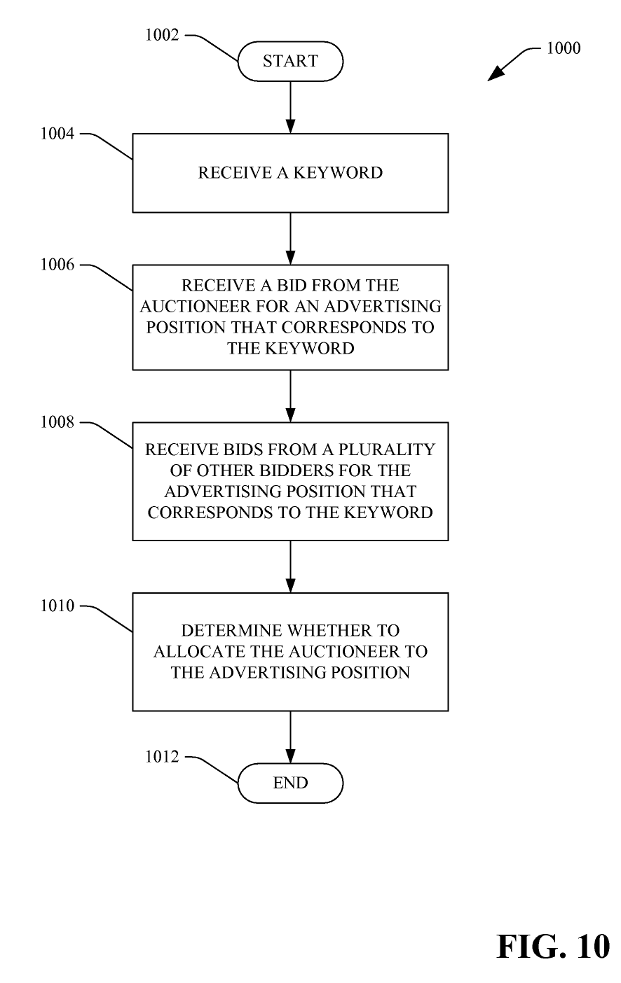

With reference now to FIGS. 10-14, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like.

Referring specifically to FIG. 10, an example methodology 1000 for executing an auction when an auctioneer is a bidder is illustrated. The methodology 1000 starts at 1002, and at 1004 a keyword is received. For instance, the keyword may be at least a portion of a search query proffered to a search engine by a user.

At 1006, a bid from the auctioneer is received, wherein the bid is for an advertising position that corresponds to the keyword. For instance, the bid may be a sealed bid. At 1008, bids from a plurality of other bidders are received, wherein the bids are for the advertising position that corresponds to the keyword.

At 1010, a determination is made regarding whether to allocate the auctioneer to the advertising position. For instance, the determination may be based at least in part upon a rank of the bid from the auctioneer amongst the bids from the plurality of other bidders. The methodology 1000 completes at 1012.

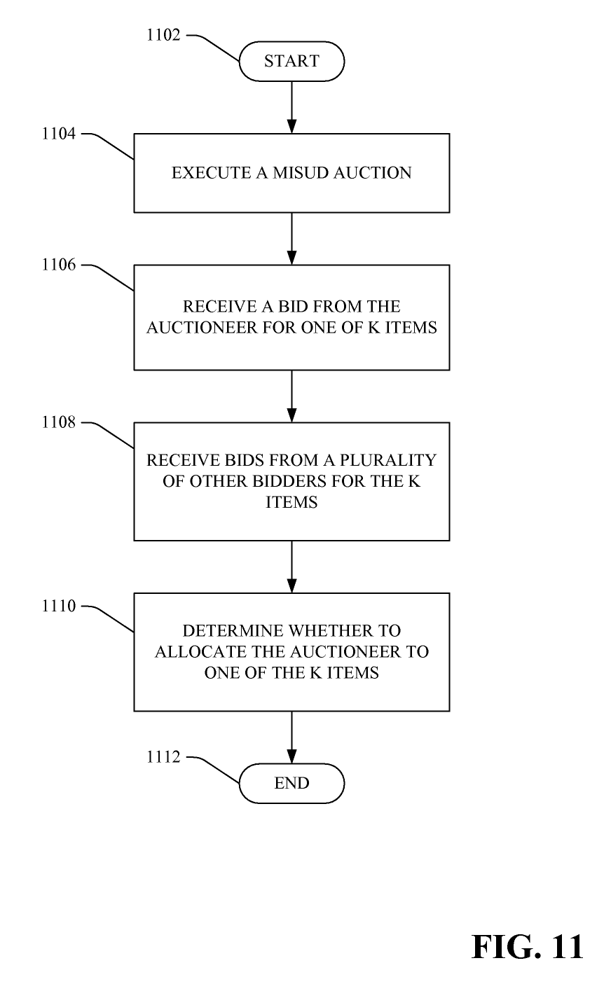

With reference now to FIG. 11, an example methodology 1100 for executing an auction when an auctioneer is a bidder is illustrated. The methodology 1100 starts at 1102, and at 1104 a multi-item single-unit demand auction is executed. For instance, the multi-item single-unit demand auction may be for k items (e.g., advertising positions).

At 1106, a bid is received from the auctioneer for one of the k items available by way of the MISUD auction. At 1108, a plurality of bids are received from other bidders, wherein the other bidders desire to purchase one of the k items.

At 1110, a determination is made regarding whether to allocate the auctioneer to one of the k items. For instance, the determination may be made based at least in part upon the rank of the bid from the auctioneer amongst the bids from the plurality of other bidders. The methodology 1100 then completes at 11 12.

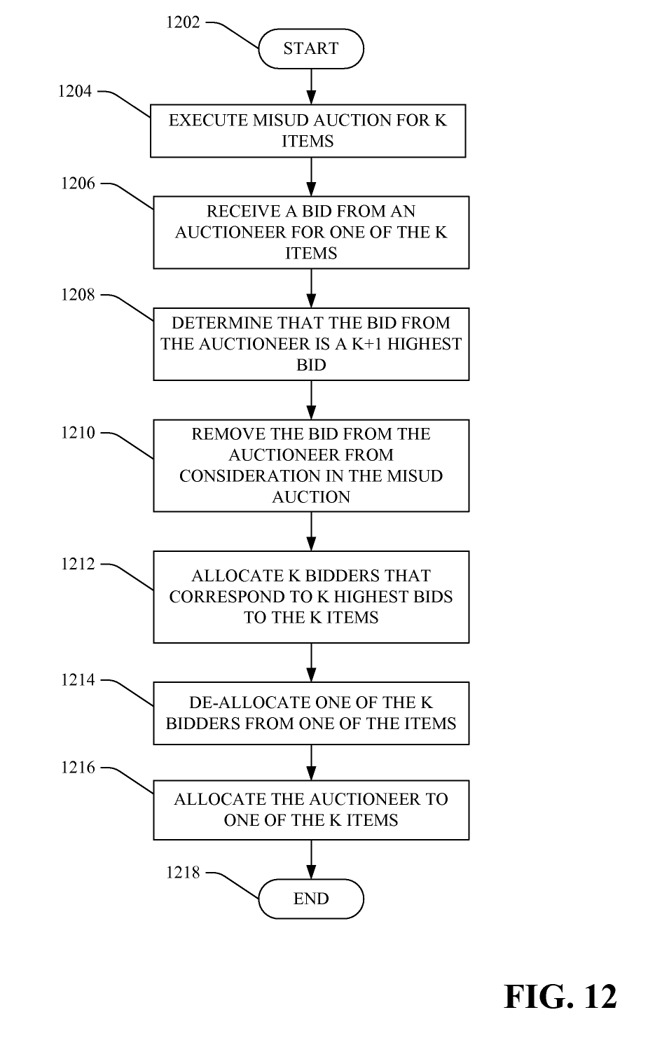

Turning now to FIG. 12, an example methodology 1200 for executing when an auctioneer is also a bidder is illustrated. The methodology 1200 starts at 1202, and at 1204 a MISUD auction for k is executed. For instance, the items may be advertising positions that can be utilized to depict advertisements to a user, wherein the advertisements correspond to a search query proffered by the user.

At 1206, a bid from the auctioneer for one of the k items is received. At 1208, a determination is made that the bid from the auctioneer is the k+1 highest bid. At 1210, the bid from the auctioneer is removed from consideration in the MISUD auction.

At 1212, k bidders that correspond to k highest bids are allocated to the k advertising positions. At 1214, one of the k bidders is de-allocated from one of the k advertising positions. Thus, one of the k highest bidders does not win the auction. The one of the k bidders may be de-allocated randomly. In another example, the one of the k bidders may be de-allocated by way of a deterministic rule.

At 1216, the auctioneer is allocated to one of the k items. Thus, even though the auctioneer was not one of the k highest bidders, the auctioneer may still be allocated to an item. Furthermore, a price charged to winners of the auction may correspond to a bid submitted by the k+2 bidder. The methodology 1200 completes at 1218.

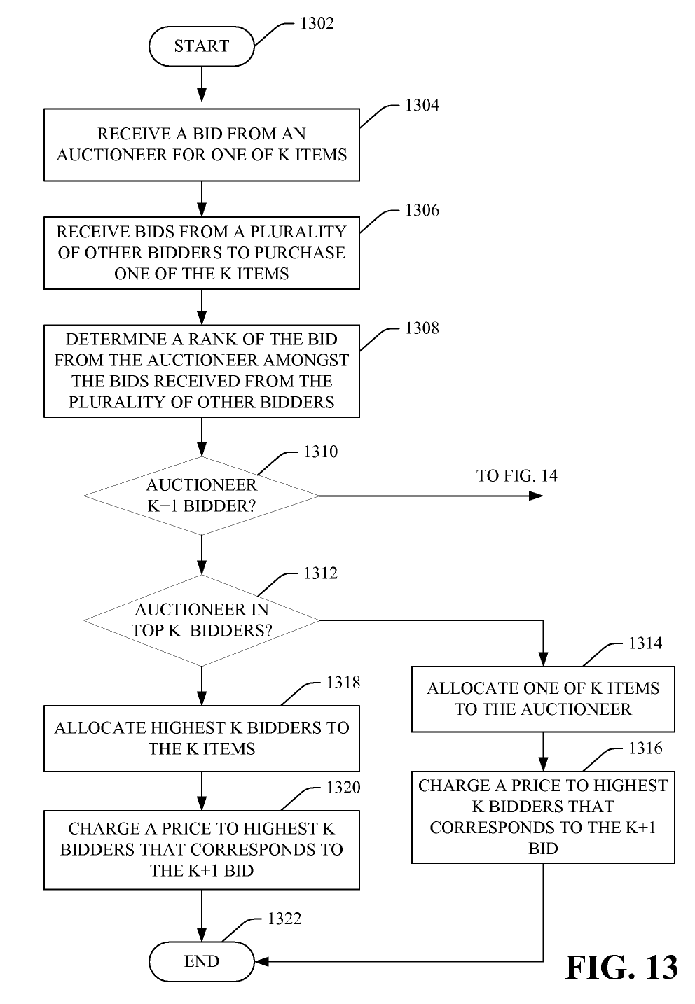

Now referring to FIG. 13, a methodology 1300 for executing a MISUD auction for k items is illustrated. In the example methodology 1300, an auctioneer is a bidder in the multi-unit single-item demand auction.

The methodology 1300 starts at 1302, and at 1304 a bid is received from an auctioneer to purchase one of k items. At 1306, bids from a plurality of other bidders are received, wherein the plurality of other bidders desire to purchase one of the k items.

At 1308, a rank of the bid from the auctioneer amongst the bids received from the plurality of other bidders is determined. For instance, a determination can be made regarding whether the auctioneer is a highest bidder, one of k highest bidders, a k+1 bidder, etc.

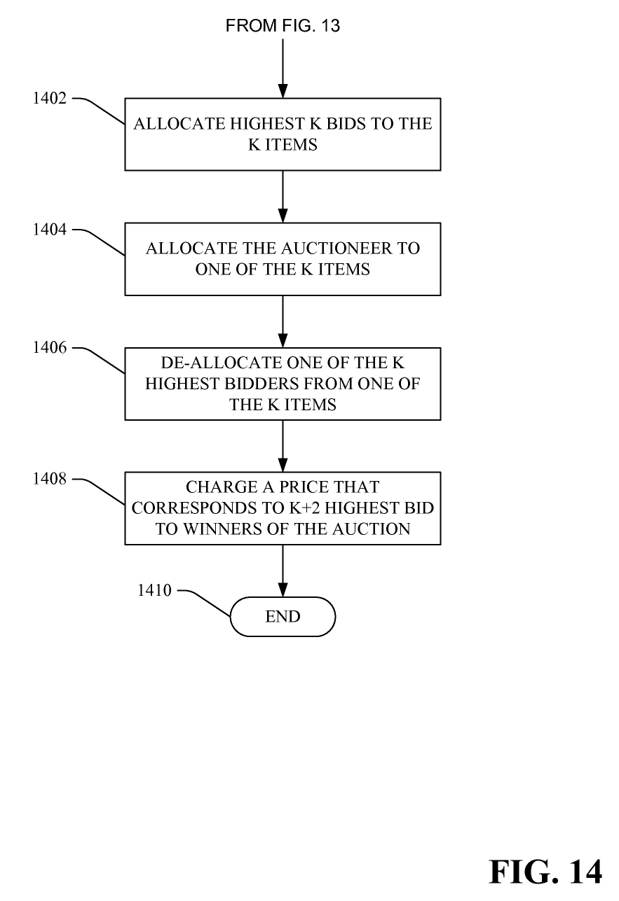

At 1310, a determination is made regarding whether the auctioneer is a k+1 highest bidder. More specifically, a determination is made regarding whether the bid submitted by the auctioneer is a k+1 highest bid. If the auctioneer is determined to be the k+1 highest bidder, the methodology 1300 proceeds to FIG. 14, which will be described in detail below. If it is determined that the auctioneer is not the k+1 highest bidder, the methodology 1300 proceeds to FIG. 1312.

At 1312, a determination is made regarding whether the auctioneer is one of k highest bidders for the k items. If it is determined that the auctioneer is one of the k highest bidders, the methodology 1300 proceeds to 1314. At 1314, the auctioneer is allocated to one of the k items. At 1316, the auctioneer is charged a price that corresponds to a bid from a k+1 highest bidder. Other winners of the auction may also be charged a price that corresponds to the bid from the k+1 highest bidder.

If at 1312 a determination is made that the auctioneer is not one of the k highest bidders for the k items (e.g., it is determined that the auctioneer is not one of the highest k+1 bidders), the methodology 1312 proceeds to 1318, and at 1318 a highest k bidders are allocated to the k items. At 1320, the highest k bidders are charged a price that corresponds to a bid from a k+1 highest bidder. The methodology 1300 may then complete at 1322.

With reference now to FIG. 14, acts of the methodology 1300 are illustrated if it is determined at 1310 (FIG. 1) that the auctioneer is the k+1 bidder. At 1402, a highest k bidders are allocated to the k items. At 1404, the auctioneer is allocated to one of the k items. Thus, the k items are overpacked (e.g., k+1 bidders are allocated to k items).

At 1406, one of the highest k bidders is de-allocated from one of the k items, creating k winners of the auction (including the auctioneer). At 1408, the k winners of the auction are charged a price that corresponds to a bid from a k+2 highest bidder. It is to be understood, however, that the price charged to the k winners may correspond to a bid from a k+3 highest bidder (or a lower ranked bidder). In this example, the methodology 1300 completes at 1410.

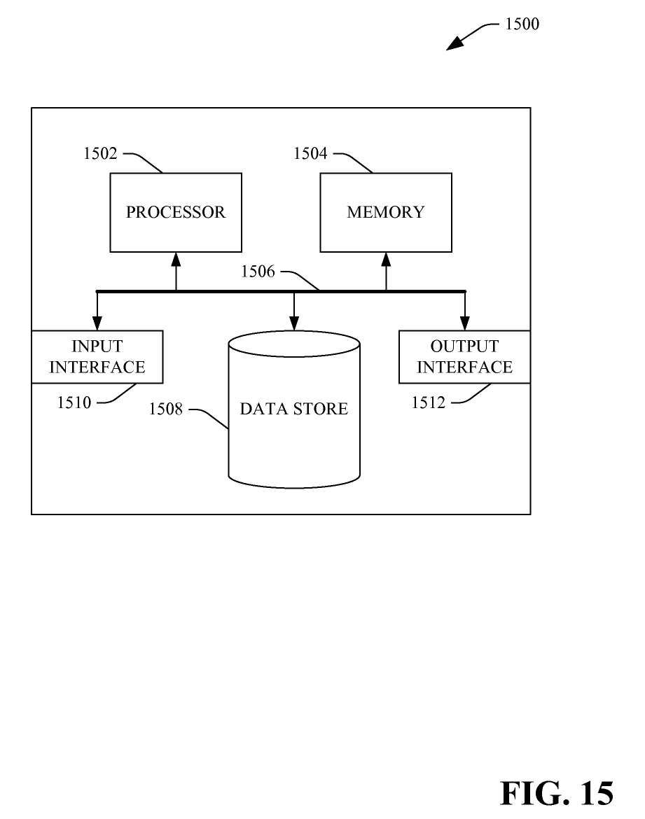

Now referring to FIG. 15, a high-level illustration of an example computing device 1500 that can be used in accordance with the systems and methodologies disclosed herein is illustrated. For instance, the computing device 1500 may be used in a system that can facilitate executing a positional auction, a multi-item single-unit demand auction, a single-item auction, or other suitable auction. The computing device 1500 includes at least one processor 1502 that executes instructions that are stored in a memory 1504. The instructions may be, for instance, instructions for implementing functionality described as being carried out by one or more components discussed above or instructions for implementing one or more of the methods described above. The processor 1502 may access the memory 1504 by way of a system bus 1506. In addition to storing executable instructions, the memory 1504 may also store weights, bidder identities, bids, click-through rates, etc.

The computing device 1500 additionally includes a data store 1508 that is accessible by the processor 1502 by way of the system bus 1506. The data store 1508 may include executable instructions, advertisements, identities of bidders, weights, etc. The computing device 1500 also includes an input interface 1510 that allows external devices to communicate with the computing device 1500. For instance, the input interface 1510 may be used to receive instructions from an external computer device, a keyword, a click on an advertisement, etc. The computing device 1500 also includes an output interface 1512 that interfaces the computing device 1500 with one or more external devices. For example, the computing device 1500 may transmit a search results page and advertisements by way of the output interface 1512.

Additionally, while illustrated as a single system, it is to be understood that the computing device 1500 may be a distributed system. Thus, for instance, several devices may be in communication by way of a network connection and may collectively perform tasks described as being performed by the computing device 1500.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A system that facilitates executing an auction when an auctioneer is also a bidder, comprising the following computer-executable components:
a receiver component that receives an indication that an auction is to be executed;
an identifier component that determines that the auctioneer is a bidder in the auction; and
an auction component that executes an auction for one or more items based at least in part upon a determination that the auctioneer is a bidder and a rank of the bid of the auctioneer amongst all receive bids.

2. The system of claim 1, wherein the auction component executes an auction for a single item, wherein the auctioneer is one of two highest bidders for the item, and wherein the auction component allocates the auctioneer to the single item.

3. The system of claim 1, wherein the auction component executes an auction for k items, wherein the auctioneer is one of k highest bidders, and wherein the auction component allocates one of the k items to the auctioneer at a price that corresponds to a bid of a k+1 highest bidder.

4. The system of claim 1, wherein the auction component executes an auction for k items, wherein the auctioneer is not one of k+1 highest bidders, and wherein the auction component does not allocate one of the k items to the auctioneer.

5. The system of claim 1, wherein the auction component executes an auction for k items, wherein the auctioneer is a k+1 highest bidder, and wherein the auction component allocates one of the k items to the auctioneer at a price that corresponds to a bid of a k+2 bidder.

6. The system of claim 5, wherein the auction component allocates the k highest bidders and the auctioneer to the k items, wherein the system further comprises a randomizer component that selectively removes one of the k highest bidders from the auction.

7. The system of claim 5, wherein the auction component allocates k highest bidders and the auctioneer to the k items, wherein the system further comprises a rules component that executes a deterministic rule to selectively remove one of the k highest bidders from the auction.

8. The system of claim 1, wherein the auction is a keyword auction.

9. The system of claim 1, wherein the auctioneer is a search engine.

10. The system of claim 1, wherein the auction component uses one of a Vickrey auction mechanism, a Vickrey-Clarke-Groves auction mechanism, or a generalized second price auction mechanism when executing the auction.

11. The system of claim 1, wherein the auction is a multi-item single-unit demand auction.

12. The system of claim 1, wherein the auction component allocates bidders to items based at least in part upon weighted bids received from a plurality of bidders.

13. The system of claim 1, further comprising:
an item identifier component that determines a number of items that are available by way of the auction;
a rank determiner component that determines where a bid from the auctioneer ranks in comparison to bids received from other bidders; and
an allocator component that allocates bidders to items based at least in part upon whether the auctioneer is a bidder, a rank of a bid of the auctioneer as determined by the rank determiner component, and a number of items available for purchase by way of the auction as determined by the item identifier component.

14. A method for executing an auction when an auctioneer is a bidder comprising the following computer-executable acts:
receiving a keyword;
receiving a bid from the auctioneer for an advertising position that corresponds to the keyword;
receiving bids from a plurality of other bidders for the advertising position that corresponds to the keyword;
determining whether to allocate the auctioneer to the advertising position based at least in part upon a rank of the bid from the auctioneer amongst the bids from the plurality of other bidders.

15. The method of claim 14, further comprising:
determining that the bid from the auctioneer is either a highest bid or a second highest bid; and
allocating the auctioneer to the advertising position.

16. The method of claim 14, further comprising:
executing a multi-item single-unit demand auction for k advertising positions; and
determining whether to allocate the auctioneer to one of the k advertising positions based at least in part upon the rank of the bid from the auctioneer amongst the bids from the plurality of other bidders.

17. The method of claim 16, further comprising:
determining that the bid from the auctioneer is not amongst k+1 highest bids from the other bidders;
allocating k bidders that correspond to k highest bids from the other bidders to the k advertising positions; and
charging a price that corresponds to a k+1 highest bid.

18. The method of claim 16, further comprising:
determining that the bid from the auctioneer is amongst k highest bids received from the other bidders and the auctioneer;
allocating the auctioneer to one of the k advertising positions; and
charging a price that corresponds to a k+1 highest bid.

19. The method of claim 16, further comprising:
determining that the bid from the auctioneer is a k+1 highest bid from amongst the bids received from the other bidders and the auctioneer;
removing the bid from the auctioneer from consideration;
allocating k bidders that correspond to k highest bids to the k advertising positions;
de-allocating one of the k bidders from one of the k advertising positions; and
allocating the auctioneer to one of the k advertising positions.

20. A computer-readable medium comprising instructions that, when executed by a computer, perform the following acts:
executing a multi-item single-unit demand auction for k items, where an auctioneer is a bidder in the multi-item single-unit demand auction, wherein executing the multi-item single-unit demand auction comprises:
receiving a bid from an auctioneer to purchase one of the k items;
receiving bids from a plurality of other bidders to purchase one of the k items;
determining a rank of the bid from the auctioneer amongst the bids received from the plurality of other bidders;
if the auctioneer is not one of k+1 highest bidders:
allocating a highest k bidders to the k items; and
charging the highest k bidders a price that corresponds to a bid from a k+1 highest bidder;
if the auctioneer is one of k highest bidders:
allocating the auctioneer to one of the k items; and
charging the auctioneer a price that corresponds to a bid from a k+1 highest bidder; and
if the auctioneer is a k+1 highest bidder:
allocating a highest k bidders to the k items;
allocating the auctioneer to one of the k items;
de-allocating one of the highest k bidders from one of the k items, creating k winners of the auction; and
charging a price to the k winners of the auction that corresponds to a bid from a k+2 highest bidder.
